(19) United States
(12) Patent Application Publication
(10) Pub. No.: US 2018/0114463 A1
(43) Pub. Date: Apr. 26, 2018

(54) MATHEMATICAL TEACHING APPARATUSES AND METHODS OF USE

(71) Applicant: Eric LeMasters, Santa Fe, NM (US)

(72) Inventor: Eric LeMasters, Santa Fe, NM (US)

(21) Appl. No.: 15/339,764

(22) Filed: Oct. 31, 2016

Related U.S. Application Data
(63) Continuation-in-part of application No. 15/332,924, filed on Oct. 24, 2016.

(51) Int. Cl. G09B 19/02; G09B 1/02

(52) U.S. Cl. CPC G09B 19/02; G09B 1/02

(57) ABSTRACT

Mathematical teaching apparatuses and methods of use are provided herein. In one embodiment a mathematical teaching apparatus includes a frame having a plurality of spaced apart rods, and an equal number of beads disposed on each of the plurality of spaced apart rods to create beaded rows. Each of the equal number of beads of the beaded rows is identical in size such that the beaded rows form a square when the beaded rows are disposed on a furthermost edge of the frame.

### CROSS REFERENCE TO RELATED APPLICATIONS

This application is a continuation-in-part of U.S. non-provisional patent application Ser. No. 15/332,924, filed Oct. 24, 2016, the entire contents of which is incorporated herein by reference.

### FIELD OF THE INVENTION

The present technology is directed to teaching apparatuses, and more specifically, but not by way of limitation, to mathematical teaching apparatuses and methods of use. Some embodiments comprise a graphically accurate classroom abacus that can be utilized to teach math facts such as addition, subtraction, multiplication and division, along with the fundamentals of fractions, decimals, percent, ratios, and geometry using a graphically accurate model.

### SUMMARY

In one aspect, a mathematical teaching apparatus is provided having a plurality of rods and a plurality of beads disposed on each rod. In one approach the apparatus is configured as an abacus wherein the spacing between the rods and the size of the beads are dimensioned such that when ten beads on each of ten rods are disposed together in a resting “zero” position in a 10 bead by 10 bead configuration, the beads together form a square. According to some embodiments, the present technology is directed to a mathematical teaching apparatus, comprising: (a) a frame comprising ten spaced apart rods forming ten rows; and (b) ten beads disposed on each of the ten rods, wherein each of the ten beads are sized such that the ten rows comprising ten beads form a square when the beads are disposed in a resting position.

In some embodiments, the present disclosure is directed to a system of one or more computers which can be configured to perform particular operations or actions by virtue of having software, firmware, hardware, or a combination of these installed on the system that in operation causes or cause the system to perform the actions and/or method steps described herein. One or more computer programs can be configured to perform particular operations or actions by virtue of including instructions that, when executed by the data processing apparatus, cause the apparatus to perform the actions. One general aspect includes actions such as (a) displaying a mathematical teaching apparatus in the form of a graphical user interface, the graphical user interface comprising: (i) a display of a plurality of spaced apart rods on a graphical user interface; and (ii) a display of an equal number of beads disposed on each of the plurality of spaced apart rods to create beaded rows, wherein each of the equal number of beads of the beaded rows are identical in size such that the beaded rows form a square when the beaded rows are disposed in a resting field configuration; and (b) receiving user input to move at least a portion of the beads of the beaded rows to slide a portion of the beads along their respective rods to graphically illustrate any of the geometric values and angles.

In another embodiment, the present disclosure comprises a mathematical teaching apparatus having: (a) a frame comprising a plurality of spaced apart rods within the frame; and (b) an equal number of beads disposed on each of the plurality of spaced apart rods to create beaded rows, (c) wherein each of the equal number of beads of the beaded rows are identical in size such that the beaded rows form a square when the beaded rows are disposed on a furthermost edge of the frame.

In another aspect, Eric LeMasters has invented a new, original ornamental design for a mathematical teaching apparatus/article, as set forth herein and shown in the accompany figures. The broken lines shown in the figures show portions of the article which form no part of the claimed design, that is, no part of the ornamental design for a mathematical teaching article, as shown and described.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is an example mathematical teaching apparatus, constructed in accordance with an embodiment of the present disclosure;

FIG. 2 illustrates an example calculation using the mathematical teaching apparatus to teach square numbers according to an embodiment;

FIG. 3 illustrates an example calculation using the mathematical teaching apparatus to teach an area model and/or proportionality according to an embodiment;

FIG. 4 illustrates an example calculation using the mathematical teaching apparatus to visually diagram an angle using triangles according to an embodiment;

FIG. 5 illustrates the mathematical teaching apparatus being used to teach the calculation and visualization of geometrical values according to an embodiment;

FIG. 6 illustrates an example calculation using the mathematical teaching apparatus to solve an algebraic equation according to an embodiment;

FIG. 7 illustrates a graphical user interface generated by an application executing on a computing device, the GUI comprising a virtual mathematical teaching apparatus according to an embodiment;

FIG. 8 illustrates the use of the virtual mathematical teaching apparatus and display of solution to an algebraic equation using the virtual mathematical teaching apparatus according to an embodiment;

FIG. 9 is a flowchart of an example method of an embodiment of the present disclosure;

FIG. 10 is an example computing device that can be used to practice aspects of the present technology;

FIG. 11 is an example mathematical teaching apparatus, constructed in accordance with another embodiment of the present disclosure;

FIG. 12 is perspective view of a mathematical teaching apparatus according to an embodiment;

FIG. 13 is a front view of the apparatus of FIG. 12;

FIG. 14 is a rear view of the apparatus of FIG. 12;

FIG. 15 is a top view view of the apparatus of FIG. 12;

FIG. 16 is a bottom view of the apparatus of FIG. 12;

FIG. 17 is a right side of the apparatus of FIG. 12;

FIG. 18 is a left side of the apparatus of FIG. 12;

FIG. 19 is perspective view of a mathematical teaching apparatus according to an embodiment;

FIG. 20 is a front view of the apparatus of FIG. 19;

FIG. 21 is a rear view of the apparatus of FIG. 19;

FIG. 22 is a top view view of the apparatus of FIG. 19;

FIG. 23 is a bottom view view of the apparatus of FIG. 19;

FIG. 24 is a rights side view of the apparatus of FIG. 19; and

FIG. 25 is a left side view of the apparatus of FIG. 19.

### DETAILED DESCRIPTION OF PREFERRED EMBODIMENTS

The present disclosure is related to mathematical teaching apparatuses and methods of use. In one embodiment, the mathematical teaching apparatuses are specifically configured abacuses that allow for the graphical illustration of math facts such as addition, subtraction, multiplication and division, along with the fundamentals of fractions, decimals, percent, ratios, and geometry in a graphically accurate model.

For context, many problems or deficits inherent in math learning and understanding are forefront issues facing education and society as a whole. Quantitative and qualitative mastery of basic math facts and computation is possible using the present disclosure. The apparatuses of the present disclosure supplement and/or replace many commonly used math models and manipulatives by providing a graphically accurate model used to extend and illustrate concepts such as graphically accurate square numbers, angles, ratios, and so forth.

Unlike the Asian-influenced Soroban, the Russian Schoty and other types of counting frames, some embodiments of the mathematical teaching apparatuses of the present disclosure utilize a 100 bead (10 row, 10 beads/row) classroom abacus where a counting field area of beads forms a perfect square when the beads are in a “resting” or zero (0) position, that is, the beads are pushed all to one side of the apparatus. By placing the beads in this fashion, like a piece of graph paper, square numbers can be shown as true squares. Angles and relative measurements are true. Quantities and ratios are accurate. Abacuses having beads not capable of forming a square in a “resting” or zero (0) position cannot accurately model certain mathematical relationships such as geometries and angles.

To be sure other configurations and permutations of numbers of beads and rows of beads can be utilized so long as the beads form a perfect square when the beads are in a “resting” or zero (0) position.

These and other advantages of the present disclosure are disclosed herein with reference to the collective accompanying drawings.

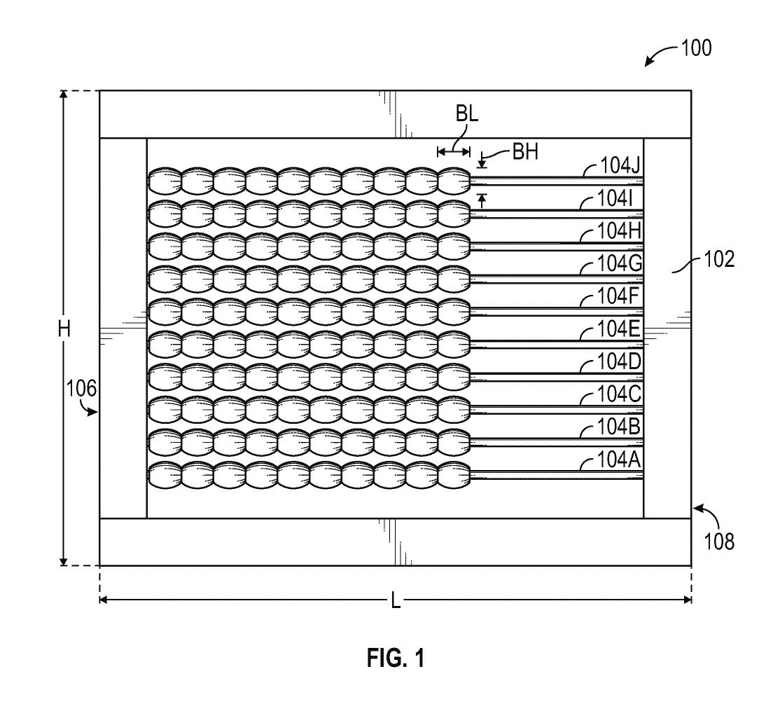

FIG. 1 is an example mathematical teaching apparatus 100 that comprises a frame 102 and a plurality of rods, such as rods/rows 104A-J. The frame 102 has two furthermost edges such as left edge 106 and right edge 108. In some embodiments, each of the plurality of rods extends between the left edge 106 and the right edge 108.

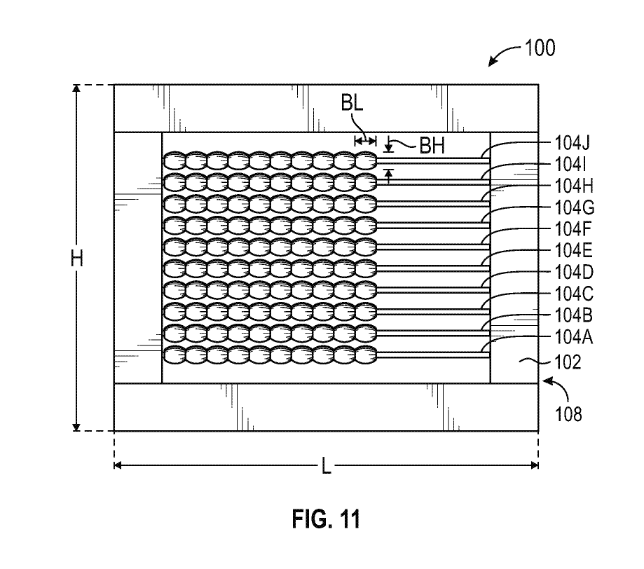

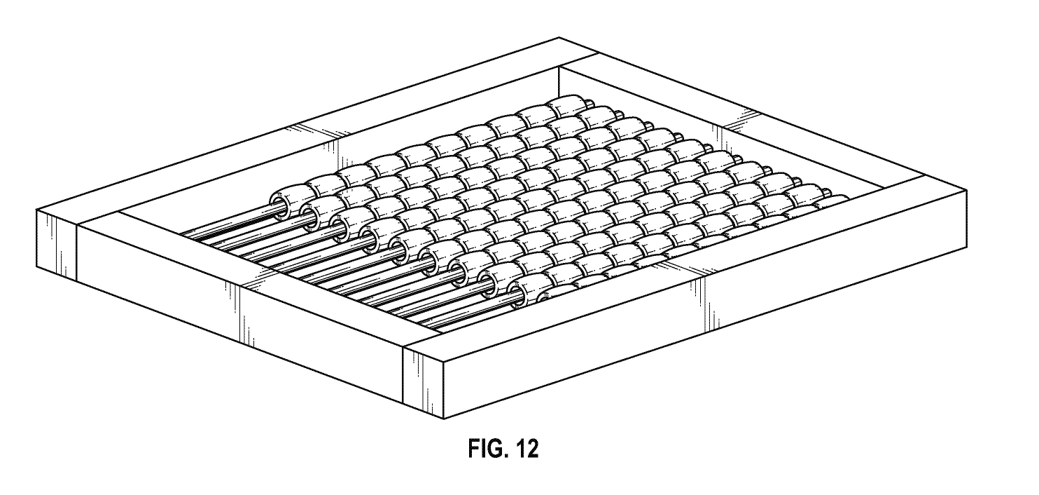

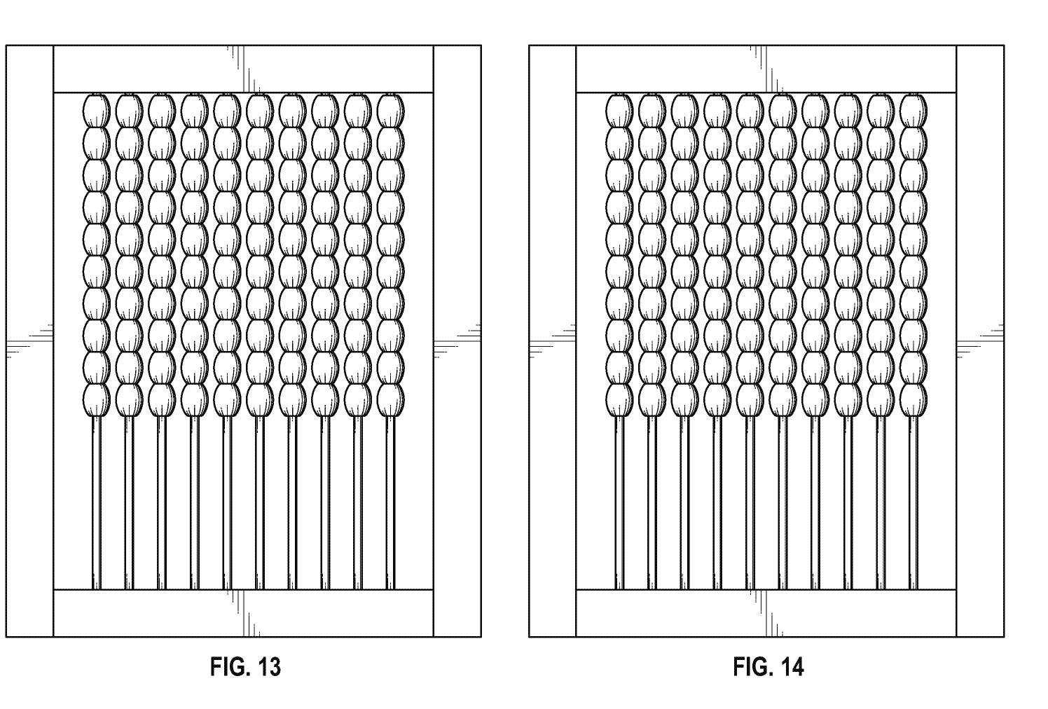

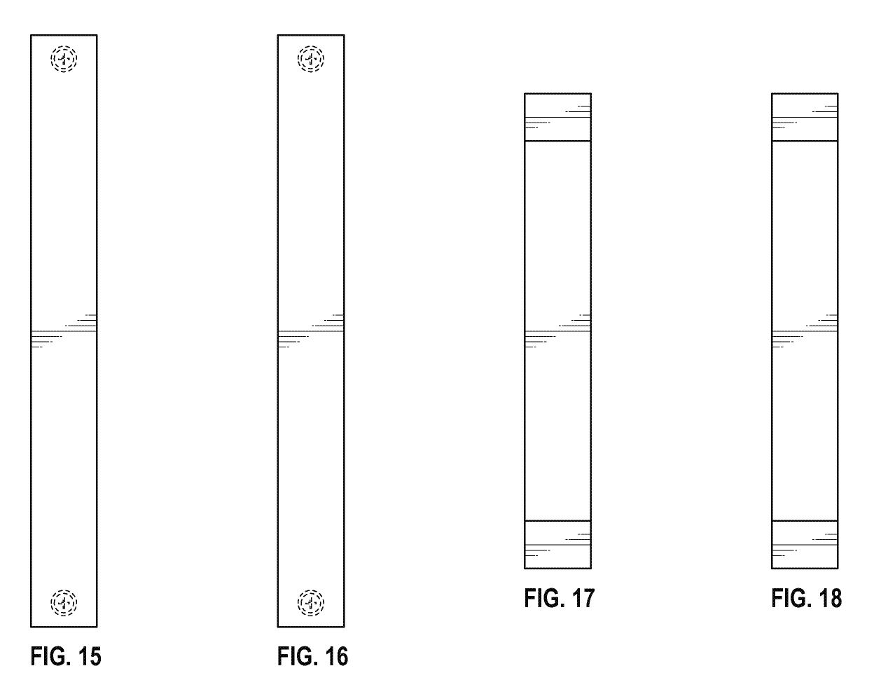

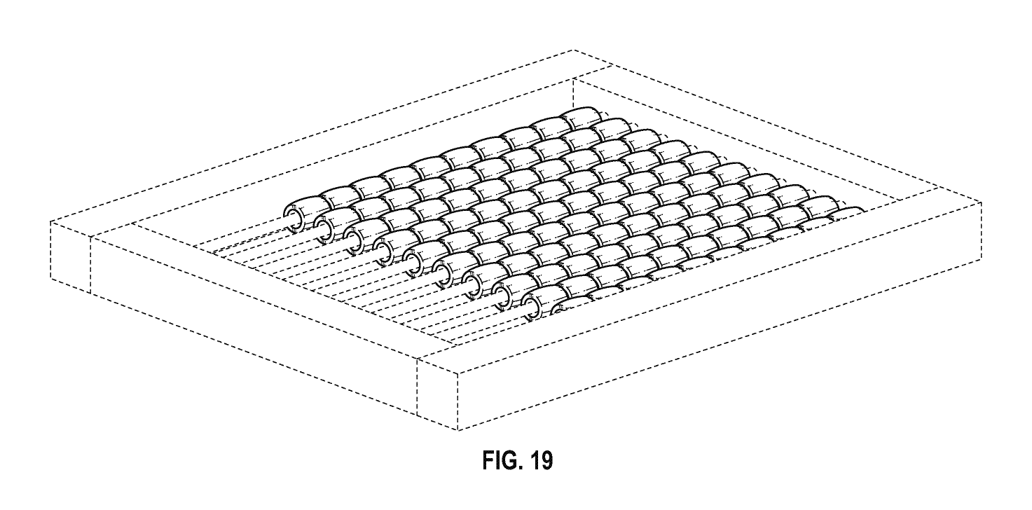

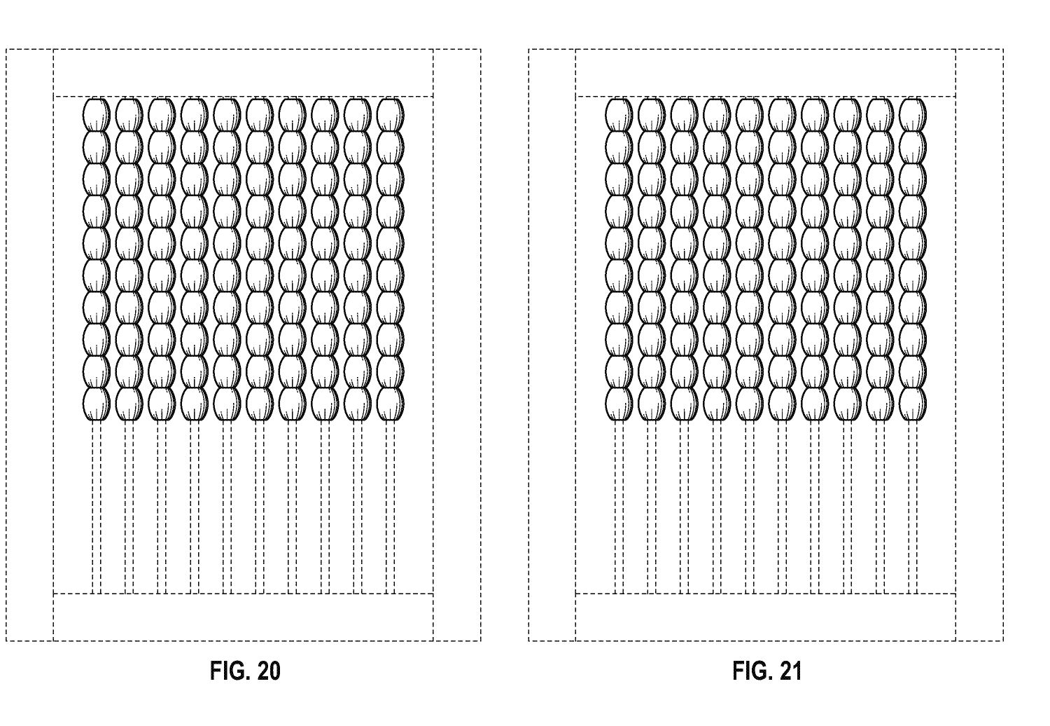

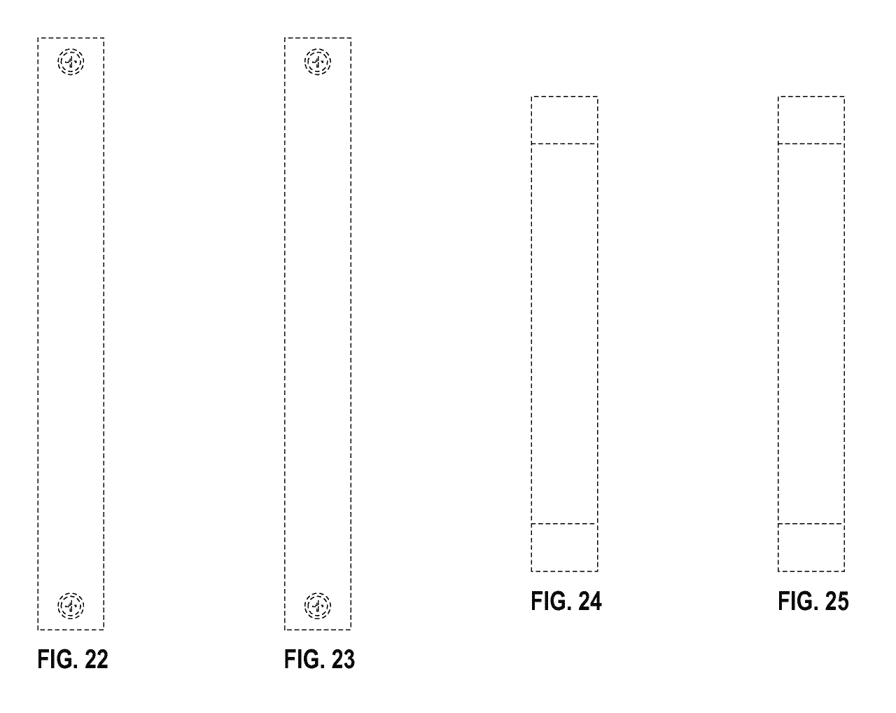

In one embodiment, the frame 102 is sized such that its height H and length L have a ratio of approximately 2:3, inclusive, such as shown in FIG. 11. The plurality of rods forms rows that are spaced apart from one another to accommodate beads.

Each of the plurality of rods comprises a plurality of beads, such as bead 110 that are associated with their respective rod in such a way that the bead can freely traverse along the rod. That is, each bead comprises an aperture that allows the bead to be threaded onto a rod.

The shape of the beads and the space between rows of beads is variable, dependent on the size and appearance desired, so long as the resting field of beads is square.

In one embodiment, a 2:3 ratio is utilized where the bead 110 comprises a bead height Bh of two units by bead length Bl of three units. Again, any configuration and bead size is acceptable so long as the beads form a square when the beads are in a “resting” or zero (0) position.

To be sure, the apparatus 100 is illustrated in the “resting” or zero (0) position in FIG. 1 where all beads are pushed to the leftmost edge 106.

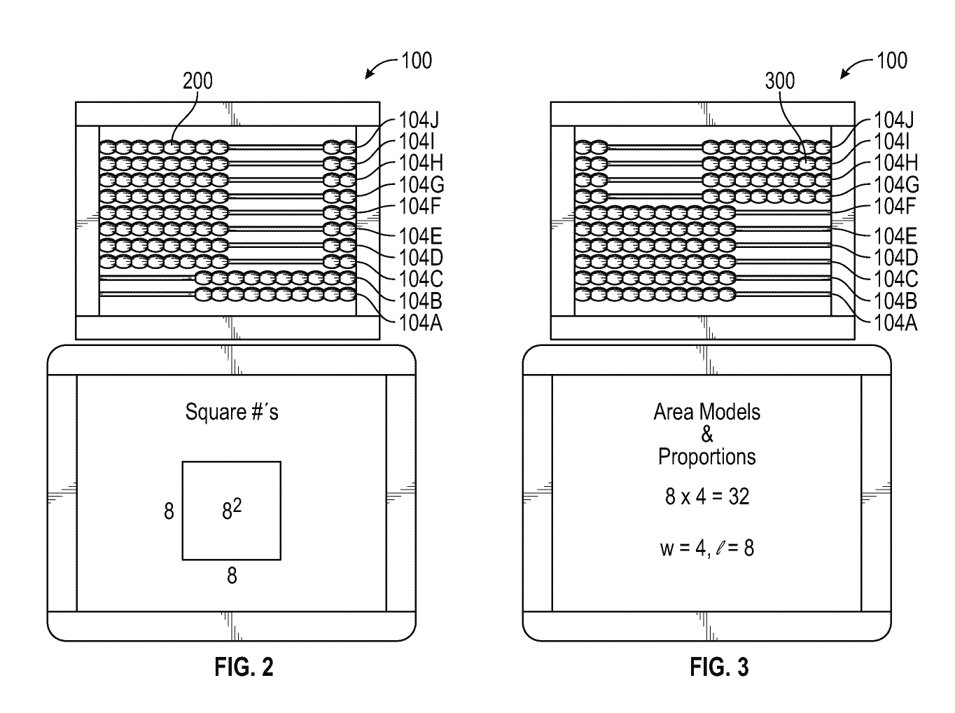

In FIG. 2, the apparatus 100 has been utilized to illustrate a square number relationship 8×8. An 8×8 grouping of beads 200 is created by moving all beads in the two bottom rows 104A-B to the right edge 108. The last two beads of rows 104C-J are also moved to the right edge 108, leaving the grouping of beads 200.

In FIG. 3, the apparatus 100 has been utilized to illustrate area models and proportions. An 8×4 (where width is four and length is eight) grouping of beads 300 is created by moving all but two beads in the top rows 104G-J to the right edge 108. The beads of rows 104A-F are unmoved, leaving the grouping of beads 300.

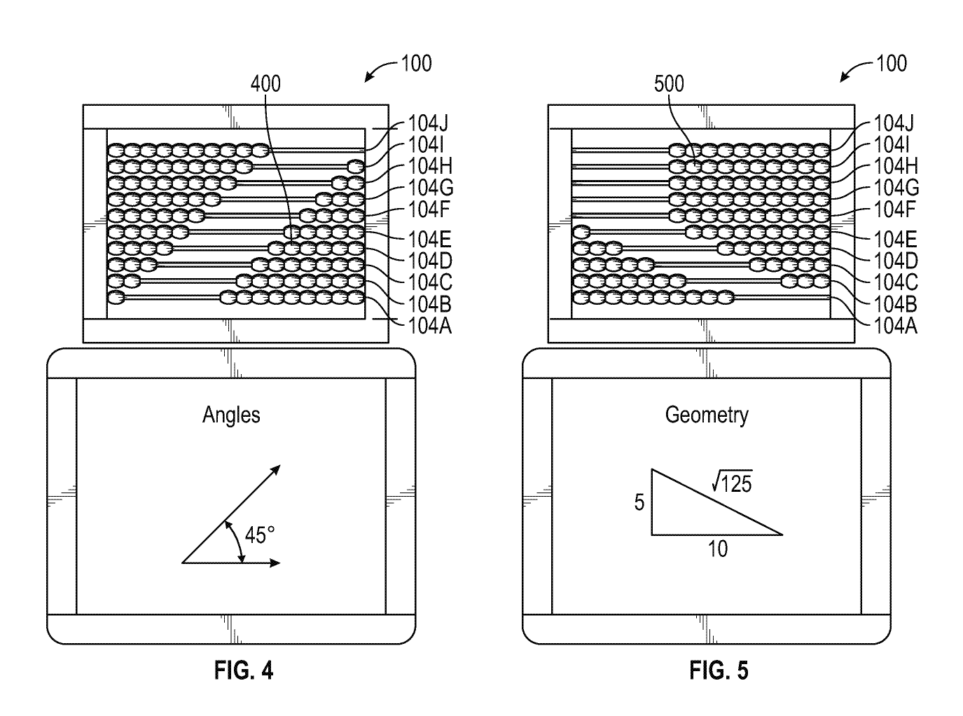

In FIG. 4, the apparatus 100 has been utilized to illustrate a 45 degree angle. A grouping of beads 400 is created by moving: a single bead from row 104I; two beads from row 104H; three beads from row 104G; four beads from row 104F; five beads from row 104E; six beads from row 104D; seven beads from row 104C; eight beads from row 1048; and nine beads from row 104A, all of which are moved to the right edge 108. The grouping of beads 400 (a first right triangle) is separated from remaining beads (a second right triangle) on the left edge 106 to illustrate a 45 degree angle.

In FIG. 5, the apparatus 100 has been utilized to illustrate an answer to a geometrical problem. A grouping of beads 500 is created by moving: all beads from rows 104F-J to the right side 108; all beads but one from row 104E; all but three beads from row 104D; all but five beads from row 104C; all but seven beads from row 1048; and no beads from row 104A. The grouping of beads 500 represents the calculation of a length of a hypotenuse of a right triangle.

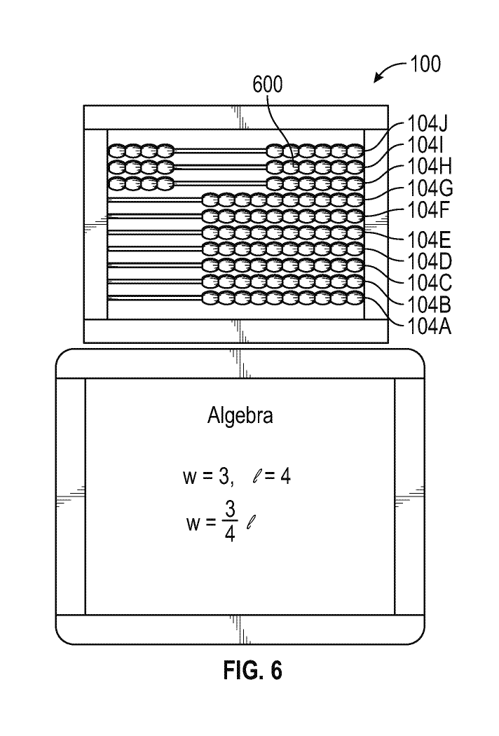

In FIG. 6, the apparatus 100 has been utilized to illustrate an algebraic relationship 3×4. A 3×4 grouping of beads 600 is created by moving all beads in the bottom rows 104A-G to the right edge 108. The last six beads of rows 104H-J are also moved to the right edge 108, leaving the grouping of beads 600.

In general, apparatuses of the present disclosure can be utilized to illustrate square numbers as square beads (sub-square of the counting field area of beads). The apparatuses can also be used to create accurate area models and proportions, as well as areas and perimeters. The apparatuses can also be used to illustrate multiples of numbers as rectangular area models, for example a 3×4 rectangle, where the short side is 75% of the long side.

The apparatuses can also be used to illustrate geometry and angles such as a 3-4-5 right triangle, with sides of three beads and four beads, would measure physically and visually five beads on the third side (the hypotenuse). A 45 degree angle can be shown accurately with an isosceles right triangle.

The apparatuses can also be used to illustrate concepts and skills such as addition, subtraction, multiplication and division, as well as fractions, decimals, percent values, ratios, positive/negative integers, and so forth.

It would be appreciated that in some embodiments the mathematical teaching apparatus can have a frame shape that is different from that shown in the drawings and/or can have rods that are shaped differently from those shown in the drawings.

Furthermore, in some embodiments, the frame of the teaching apparatus is a continuous structure that entirely surrounds the beads whereas in other embodiments the frame can be non-continuous in structure that only partially surround the beads and rods whilst still providing the necessary support to maintain the rods and beads in their correct configuration.

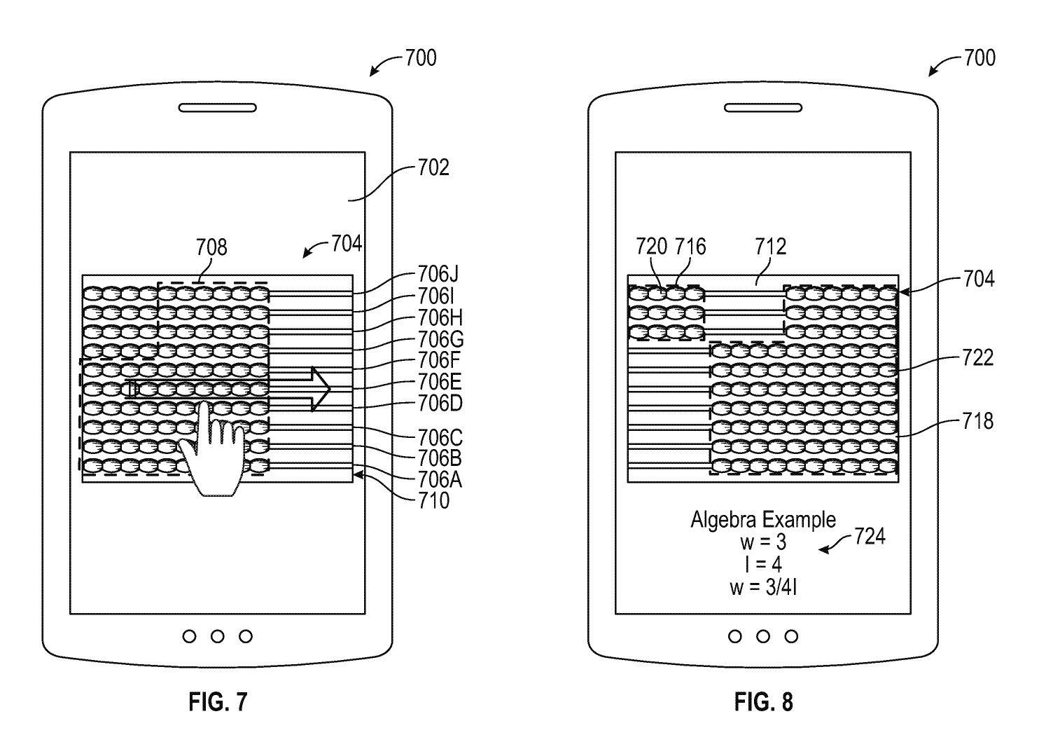

FIG. 7 illustrates an example computing device 700 that includes a touchscreen display 702. The computing device 700 comprises an Application that provides the functionalities of the mathematical teaching apparatuses described above.

The Application provides a virtual mathematical teaching apparatus 704 that includes rows of beads 706A-J. The user can manipulate the placement of the beads by touching and dragging/sliding the beads along their respective rods, although the illustration of rods is not required in all embodiments.

In use, a portion of beads such as bead group 708 can be selected by the user and slid towards a right edge 710 of the display. Beads can be moved one at a time or in groups.

FIG. 8 illustrates a template 712 that is applied to the GUI and specifically overlaid onto the bead field of the virtual mathematical teaching apparatus 704. The template 712 provides openings 716 and 718 that illustrate groupings of beads. For example, a first grouping 720 remains proximate the left edge while a second grouping 722 is disposed away on the right edge.

Indicia 724 or a visual cue is provided below the virtual mathematical teaching apparatus 704 to explain the mathematical operations or modeling caused by movement of portions of the beads in accordance with the template 712.

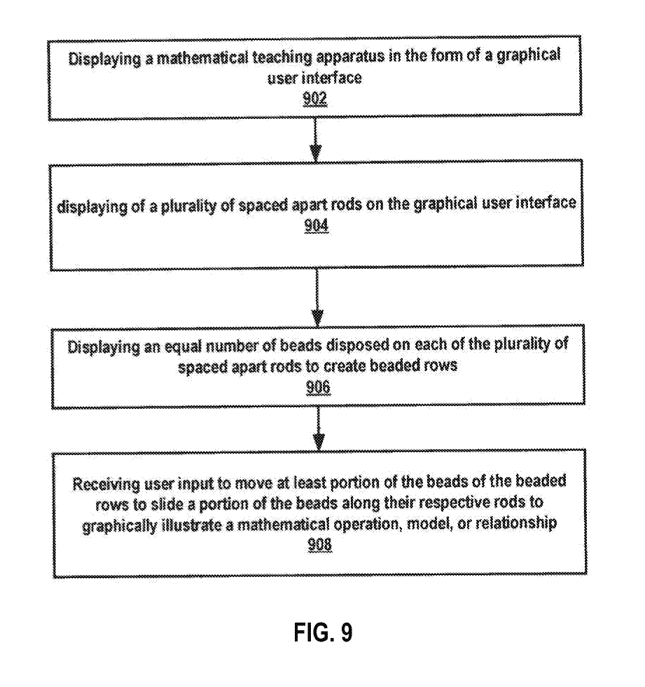

FIG. 9 is a flowchart of an example method for providing a virtual mathematical teaching apparatus. The method is preceded by downloading an application onto a computing device. The application provides the virtual mathematical teaching apparatus to a touchscreen display of the computing device.

The method includes a step 902 of displaying a mathematical teaching apparatus in the form of a graphical user interface. In some embodiments the graphical user interface is created by a step 904 of displaying of a plurality of spaced apart rods on the graphical user interface. Again, in some embodiments, the rods are not required, but are used as a visual cue that indicates to the user that beads can be slid along the rods.

The method can also comprise a step 906 of displaying an equal number of beads disposed on each of the plurality of spaced apart rods to create beaded rows. As mentioned above, each of the equal number of beads of the beaded rows is identical in size such that the beaded rows form a square when the beaded rows are disposed in a resting field configuration.

According to some embodiments, the method includes a step 908 of receiving user input to move at least a portion of the beads of the beaded rows to slide a portion of the beads along their respective rods to graphically illustrate a mathematical operation, model, or relationship. In one embodiment the beads are selectively moved to illustrate addition, subtraction, multiplication and division, as well as fractions, decimals, percent values, ratios, positive or negative integers, models, angles, and any combinations and permutations thereof.

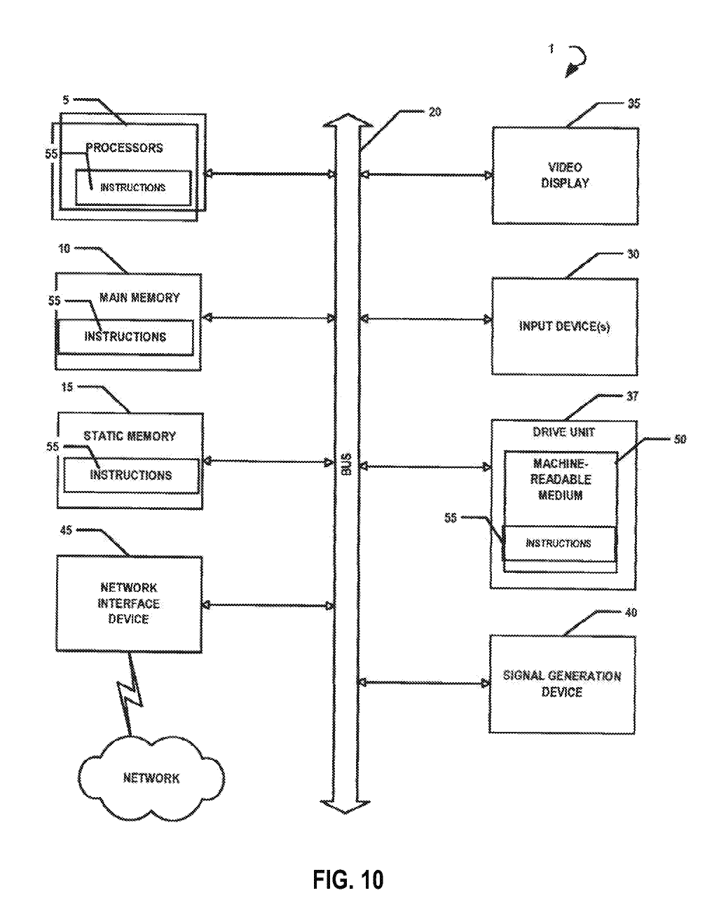

FIG. 10 is a diagrammatic representation of an embodiment of a machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a robotic construction marking device, a base station, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The embodiment of the computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A mathematical teaching apparatus, comprising:
a frame comprising ten spaced apart rods forming ten rows; and
ten beads disposed on each of the ten rods;
wherein the spacing between said rods and the size of the beads are dimensioned such that the ten rows each comprising ten beads form a square when the beads are disposed in a resting position.

2. The apparatus according to claim 1, wherein each of beads comprises a size of 2× height and 3×length.

3. The apparatus according to claim 2, wherein the frame comprises a size of 2× height and 3×length.

4. The apparatus according to claim 2, wherein the each of beads are identical in size.

5. A mathematical teaching apparatus, comprising:
a frame comprising a plurality of spaced apart rods within the frame; and
an equal number of beads disposed on each of the plurality of spaced apart rods to create beaded rows, wherein each of the equal number of beads of the beaded rows are identical in size such that the beaded rows form a square when the beaded rows are disposed on a furthermost edge of the frame.

6. The apparatus according to claim 5, wherein the beads form a resting field when disposed on a furthermost edge of the frame.

7. The apparatus according to claim 6, wherein a square number of beads moved away from the resting field forms a separate square from the remaining beads in the resting field.

8. The apparatus according to claim 6, wherein a portion of the beads in the resting field are moved away to form a first triangle, the beads remaining in the resting field form a second triangle, further wherein an angle is visually represented by the separation of the first triangle from the second triangle.

9. The apparatus according to claim 5, wherein each of beads comprises a size of 2× height and 3×length.

10. The apparatus according to claim 9, wherein the frame comprises a size of 2× height and 3×length.

11. The apparatus according to claim 9, wherein the each of beads are identical in size.

12. The apparatus according to claim 5, further comprising a template that is applied to the apparatus, wherein the template defines locations for a portion of the beads of the beaded rows that when moved according to the template illustrates a mathematical relationship or answer.

13. A method, comprising:
displaying a mathematical teaching apparatus in the form of a graphical user interface, the graphical user interface comprising:
a display of a plurality of spaced apart rods; and
a display of an equal number of beads disposed on each of the plurality of spaced apart rods to create beaded rows, wherein each of the equal number of beads of the beaded rows are identical in size such that the beaded rows form a square when the beaded rows are disposed in a resting field configuration; and
receiving user input to move at least portion of the beads of the beaded rows to slide a portion of the beads along their respective rods to graphically illustrate any of geometric values and angles.

14. The method according to claim 13, wherein the user input is utilized to selectively alter a graphic illustration any of addition, subtraction, multiplication and division, as well as fractions, decimals, percent values, ratios, positive or negative integers, using the beads.

15. The method according to claim 13, wherein the user input comprises a touch and slide of one or more beads received on a touchscreen display.

16. The method according to claim 13, further comprising applying a template to defines locations for a portion of the beads of the beaded rows that when moved according to the template illustrates a mathematical relationship, model, or answer.
